(19) United States
(12) Patent Application Publication
(10) Pub. No.: US 2016/0249643 A1
(43) Pub. Date: Sep. 1, 2016

(54) Use of Enzymes to Condition Ruminant Feedstocks

(71) Applicant: Kemin Industries, Inc., Des Moines, IA (US)

(72) Inventors: Sathishkumar Jayaraman, Chennai (IN); Anupama Venkataraman, Tamil Nadu (IN); Kulangara Paul Philip, Chennai (IN)

(21) Appl. No.: 15/057,269

(22) Filed: Mar. 1, 2016

(30) Foreign Application Priority Data
Mar. 1, 2015 (IN) 586DEL2015

(51) Int. Cl. A23K 10/12; A23K 50/10; A23K 50/20

(52) U.S. Cl. CPC A23K 10/12; A23K 50/20; A23K 50/10

(57) ABSTRACT

A method of improving milk yield in a ruminant animal a ruminant ration with an aqueous is presoaked with a solution of a composition of enzymes comprising a xylanase and a ferulic acid esterase.

### RELATED APPLICATIONS

This application claims priority to Indian Patent Application Serial No. 586/DEL/2015, filed Mar. 1, 2015, and incorporated herein in its entirety by this reference.

### BACKGROUND OF THE INVENTION

The present invention relates generally to the treatment of animal feed and, more specifically, to the conditioning of equine and ruminant feeds with a mixture of enzymes prior to feeding.

One of the biggest challenges in dairy cattle nutrition is the ability to improve fiber degradation in the rumen. The supplementation of enzymes to ruminants has for long been considered as one of the methods to improve fiber digestion and performance of animals. Several researchers have worked in supplementing enzymes to cattle but had only limited success. Some of the factors considered as challenges in the supplementation of enzymes to ruminants are the enriched proteolytic activity in the rumen, the variation in the size of the rumen across animals, and the variation in the microflora of the rumen. For these reasons, the supplementation of exogenous enzymes alongside the feed resulted in the loss of activity of enzymes in the rumen and failed to produce consistent results in improving the performance of animals.

To overcome this limitation, we propose a wetting application of enzymes to dry forages/feed raw materials for a selected amount of time after which the entire soup, if any, and partially digested forages/feed material is fed to the animal. We propose that wetting or presoaking of forages favors preliminary degradation of the cell walls in the forages and feed materials, better colonization of microbes on the forages and feed materials in the rumen, and further and enhanced fiber digestion in the rumen. This ultimately results in improved milk yield and performance of the equine or ruminant animal, particularly in dairy cattle.

### SUMMARY OF THE INVENTION

The ability of equine and ruminant animals to digest the fiber in diets, particularly diets containing forage materials, such as rice straw, wheat straw, and the like, is limited due to the phenolic acid linkages and lignin included in such materials. The issue is also of concern to a lesser extent in other feed ingredients, including cereals, grains, bran and spent cake common in ruminant diets. Another challenge is feeding enzymes to ruminant animals. In the equine digestive track and rumen, enzymes are treated as a protein source rather than a catalyst and have limited stability due to the degradation of such enzymes in the rich proteolytic and high temperature environment present.

The present invention attempts to overcome or address these challenges by wetting or presoaking the forages and other feed materials in a solution containing a mixture of enzymes. The enzymes are stable in such an environment and are able to act effectively on the forages and other feed materials which are partially digested prior to be fed to the ruminant animals. This predigested fiber, when fed to ruminant animals results in improved fiber digestibility. Also, by including both a xylanase and a ferulic acid esterase in the enzyme composition, breakdown of the phenolic acid linkages and lignin are improved. In addition, the partially digested forages result in higher microbial colonization on the forages in the equine digestive track or rumen, further aiding in fiber digestibility.

The present invention consists of the wetting application of an enzyme formulation containing xylanase and a ferulic acid esterase (FAE) to equine and ruminant feeds, including forages and other feed materials such as grain. The concept of wetting or presoaking has been traditionally used and is believed to make the solid feed materials softer and more easily digestible for the animal. This preexisting practice can be supplemented with exogenous enzymes to enhance the predigestion of the feeds.

The wetting of forages with enzymes, including ferulic acid esterase (FAE), to break down the ferulic acid cross links present in the cell wall of forages, like straw, and other feed materials. FAE hydrolyzes the ester bond between xylan and ferulic acid in the cell wall and helps in increasing the degradability of the xylan backbone by xylanase enzymes. The synergistic action of xylanase and FAE also favors access of other enzymes, like cellulase and glucanase, to further degrade the non- starch polysaccharides of the feeds. By this process of degradation of the cell wall, the fiber content in the wetted or soaked materials can be partially digested. When the equine or ruminant animal is fed the pre-digested forages or feed materials that have been presoaked with enzymes, along with the soup if any that is generated in the pre-soaking process, which will contain free reducing sugars, there is an increase in the fiber digestion in the equine digestive track or rumen leading to increased milk production and performance of the animal.

The principal elements of this invention include: (1) Formulation of the enzyme composition as a combination of xylanase with a sufficient dosage of FAE to supplement the action of xylanase in improving fiber digestibility; (2) establishment of the efficiency of the presoaking concept in the release of reducing sugars and pre-digestion of forage or feed, both in in vitro and in vivo conditions; (3) the determination of an effective dosage to improve performance/ milk yield in ruminant animals; and (4) the determination of an effective time period for the soaking of the feed materials with enzymes.

It was observed that an enzyme dosage of 500 g/ton of forage or feed material, containing between about 5% and about 95%, and preferably between about 25% and about 90%, and most preferably about 75% of xylanase and between about 1% and about 20%, and preferably between about 2% and about 10%, and most preferably about 4% of FAE with stabilizing agents and surfactants, significantly improved the sugar release in vitro and in vivo. The dosage may be varied according to requirement and current yield of the animal, and the wetting or soaking time according to the current farm practices, with a minimum wetting or soaking period of about one hour.

### BRIEF DESCRIPTION OF THE FIGURES

FIG. 1 is a chart of sugar released from the pre-soaking application of xylanase to rice straw at three different levels.

FIG. 2 is a chart of sugar released from the synergistic application of xylanase at three different levels and ferulic acid esterase at five different levels to rice straw.

FIG. 3 is a chart of sugar released from presoaking of rice straw with a control and ForaZYME XPF at 500 g/ton.

FIG. 4 is a chart of sugar released from presoaking rice straw with a control, a range of ForaZYME XPF at six levels between 100 and 1000 g/ton.

FIG. 5 is a chart of the sugar release from rice straw at using a negative control, ForaZYME XPF at 500 g/ton over incubation times from 0.5 hr to 3.5 hr.

FIG. 6 is a chart of sugar release from a total mixed ration using a negative control, ForaZYME XPF at 300 g/ton and 500 g/ton applied by spraying it on the ration.

FIG. 7 is a chart of sugar release from a total mixed ration using a negative control, ForaZYME XPF at 300 g/ton and 500 g/ton applied and presoaking the ration for 1 hour at 27° C.

FIG. 8 is a chart of sugar release from a presoaked compound pellet feed obtained from a commercial feed mill using a negative control, ForaZYME XPF at 300 g/ton and ForaZYME XPF at 500 g/ton.

FIG. 9 is a chart showing reducing sugars released from pelleted concentrate feed soaked with water or enzyme; the soaking of concentrate feed with enzymes showed more sugar release compared to control soaked in water.

FIG. 10 is a chart of reducing sugars released from TMR soaked with water or enzymes; the soaking of TMR with enzymes showed more sugar release compared to control soaked in water.

FIG. 11 is a chart of reducing sugars released from TMR sprayed with water or enzymes; the soaking of TMR with enzymes showed more sugar release compared to control sprayed with water.

FIG. 12 is a chart of reducing sugars released from sugarcane bagasse soaked with water or enzymes; the soaking of sugarcane bagasse with enzymes showed more sugar release compared to control soaked in water.

FIG. 13 is a chart of reducing sugars released from sugarcane bagasse sprayed with water or enzymes; the soaking of sugarcane bagasse with enzymes showed more sugar release compared to control sprayed with water.

FIG. 14 is a chart of reducing sugars released from soya forage soaked with water or enzymes; the soaking of soya forage with enzymes showed more sugar release compared to control soaked in water.

FIG. 15 is a chart of reducing sugars released from soya forage sprayed with water or enzymes; the spraying of soya forage with enzymes showed more sugar release compared to control sprayed with water.

FIG. 16 is a chart of the effect of ForaZYME XPF on the neutral detergent fiber content of rice straw (n=3); the pre-soaking of rice straw with ForaZYME™ XPF significantly reduced the neutral detergent fiber content.

FIG. 17 is a chart of the effects of pre-soaking with ForaZYME XPF on the lignin content of rice straw (n=3); the pre-soaking of rice straw with enzymes significantly reduced the lignin content.

FIG. 18 is a chart of the average milk yield of cattle in the early lactation phase fed a ration treated with a negative control or the same ration treated with ForaZYME XPF at 300 g/ton.

FIG. 19 is a chart of the average milk yield of cattle in the early lactation phase fed a ration treated with a negative control or the same ration treated with ForaZYME XPF at 500 g/ton.

FIG. 20 is of the average milk yield of cattle in the mid lactation phase fed a ration treated with a negative control or the same ration treated with ForaZYME XPF at 300 g/ton.

FIG. 21 is a of the average milk production per animal (L) during pre-trial and trial period showing that pre-soaking a wheat straw diet with ForaZYME™ XPF supplementation improves milk production in Murrah buffaloes compared to the pre-trial period.

FIG. 22 is a chart of the average weekly milk production per animal (L) during pre-trial and trial period showing that pre-soaking a wheat straw diet with ForaZYME™ XPF supplementation improves milk production in Murrah buffaloes compared to the pre-trial period.

FIG. 23 is a chart shows the average milk yield of the cows in early lactation phase during pretreatment and treatment periods.

FIG. 24 is a chart of the average milk yield comparison in mid-lactation cows between pretreatment and treatment period; there was an average increase of minimum 1 L per animal per day in the mid-lactation cows.

FIG. 25 is a chart of the average milk yield comparison in late lactation cows between pretreatment and treatment period.

FIG. 26 is a chart of the average milk yield per animal (L) of control and treatment group showing that the sprayed application of TMR with ForaZYME™ XPF supplementation improves milk yield in HF cows compared to control group.

### DESCRIPTION OF THE INVENTION

Even under ideal conditions, only about 60-65% of the cell walls of forage and other ruminant feed materials are degraded in the rumen. In addition, the environment of the rumen is high in proteolytic enzymes which act to degrade exogenous enzymes fed to ruminant animals or contained in animal feeds and so adversely affects the stability of the exogenous enzymes and limits their ability to perform the desired catalytic function. The present invention demonstrates the advantages of presoaking the ruminant feeds in a solution of water and a composition of a mixture of enzymes. The presoaking process initiates a degradation of the cell wall prior to ingestion by the animal and thereafter improves colonization of the ruminant microflora on the feed materials and improves fiber degradation in the rumen.

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

All publications, U.S. patent applications, U.S. patents and other references cited herein are incorporated by reference in their entireties.

The term “effective dose” or “effective amount” refers to an amount effective, at dosages and for periods of time necessary, to achieve the desired result. The effective amount of compositions of the invention may vary according to factors such as composition of the feed material, moisture content of the feed material, wetting or soaking time of the feed material and temperature. In preferred embodiments of the present invention, an effective amount of the enzyme dosage contains between about 5% and about 95%, and preferably between about 25% and about 90%, and most preferably about 75% of xylanase and between about 1% and about 20%, and preferably between about 2% and about 10%, and most preferably about 4% of FAE with stabilizing agents and surfactants. According to preferred embodiments, of the present invention, an effective amount of the enzyme dosage has enzyme activity of between about 800,000 U/g and about 1520000 U/g, and preferably between about 400,000 U/g and about 1,440,000 U/g, and most preferably about 1,200,000 U/g of xylanase and between about 4 U/g and about 80 U/g, and preferably between about 8 U/g and about 40 U/g, and most preferably about 16 U/g of FAE wherein enzyme activity is relative to the weight of the enzyme composition. Such enzyme compositions are applied to the feed materials in ranges that can readily be determined by those skilled in the art. In preferred embodiments, the enzyme compositions are applied at a rate of between about 10 g/ton and about 5,000 g/ton, preferably between about 100 g/ton and about 2,000 g/ton and more preferably between about 300 g/ton and about 1,000 g/ton. The residence of time between wetting of the feed material and feeding of the treated feed to an animal can also be readily determined by those skilled in the art. In preferred embodiments, the residence time is between about 10 minutes and 24 hours, preferably between about 30 minutes and 6 hours and more preferably between about 45 minutes and 3 hours. The temperature of the treated feed material during the residence time can also be readily determined by those skilled in the art. In preferred embodiments, the temperature is greater than about 10° C., preferably between about 20° C. and 50° C. and more preferably between about 25 ° C. and 40° C.

In view of the foregoing, embodiments according to the present invention relate to methods of growing equine and ruminant animals, particularly horses and dairy cattle, comprising feeding an animal feed diet wherein the feed further comprises xylanase and ferulic acid esterase and is added to the diet in an amount effective to enhance the digestibility of the diet, and/ or improve the performance of animal fed the diet. The diet can be an animal feed which includes high fiber materials, such as straws and roughage. The animal feed may further include sources of protein, for example, corn, soybean meal, fish meal, blood meal, meat meal, wheat-meal, rapeseed, canola and combinations of the same. The animal feed further includes carbohydrates, for example, corn, oats, barley, sorghum, or combinations of the same that can be ground into a meal for use in the animal feed. Additionally, the animal feed can include vitamins, minerals, fat, antibiotics, and other substances or compounds as necessary or desired.

As used herein the term “fiber” refers to the soluble and insoluble components of feed that are not digested by enzymes in the livestock gastrointestinal tract. The primary sources of fiber include such cell wall materials as cellulose, hemicelluloses, lignin, and pectins, along with gums and mucilages from plant material. Fiber levels in feed are assessed by a number of analytical methods known to those skilled in the art, including but not limited to determination of: Neutral Detergent Fiber (NDF), Acid Detergent Fiber (ADF) and/or Crude Fiber (CF).

Ferulic acid esterase for practicing the present invention can be obtained by growing a host cell which contains nucleic acid sequences encoding a ferulic acid esterase, under conditions which permit expression of the encoded ferulic aid esterase, optionally filtering the medium to remove the cells and collecting and concentrating the remaining supernatant by ultrafiltration to obtain the ferulic aid esterase. Beneficiary co-factor(s) can also be obtained.

As provided herein, a ferulic aid esterase enzyme may be produced by culturing a host cell as described above under conditions that permit expression of the encoded ferulic aid esterase, and collecting the expressed ferulic aid esterase. The host cell may be cultured under conditions in which the cell grows, and then cultured under conditions which cause the expression of the encoded ferulic aid esterase, or the cells may be caused to grow and express the encoded ferulic aid esterase at the same time. Such conditions are well known to one of skill in the art and may vary with the host cell and the amount of enzyme expression level desired.

The ferulic aid esterase should be present in an amount at least sufficient to achieve the intended effect. Additionally, ferulic aid esterase used in practicing the present invention can be in crude form or in pure form. Ferulic aid esterase in crude form can be prepared, for example, by separating bacterial cells which produce the ferulic aid esterase from their liquid growth media, the liquid growth media comprising crude ferulic aid esterase. Alternatively, the cells can be lysed (chemically or physically) in a liquid growth media to produce a crude, cell free extract. Other means of preparing such an extract will be apparent to persons skilled in the art. The crude ferulic aid esterase can be included in the feed in any form compatible therewith, such as in an aqueous form or in lyophilized form. In some embodiments, the crude ferulic aid esterase is in the lyophilized form.

Pure (or substantially pure) ferulic aid esterase can be obtained by separating the crude ferulic aid esterase described above into its individual constituents, in accordance with known techniques. Numerous suitable separation procedures, such as column chromatography, are known to persons skilled in the art. The individual constituent proteins can be screened for their ability to degrade ferulic aid-containing material, and that constituent which best degrades ferulic aid esterase-containing material comprises the ferulic aid esterase. Like the crude ferulic aid esterase, the pure ferulic aid esterase can be employed in any suitable form, including aqueous form and lyophilized form.

Embodiments of the present invention further relate to methods of improving the efficiency of feed utilization of an animal feed comprising feeding an animal feed wherein the feed further comprises wetting of the feed with ferulic aid esterase in an amount effective to improve the efficiency of feed utilization of an animal feed provided to equine and ruminant animals. The animal feed can include the animal feeds as described above and, in particular embodiments can be wheat and rice straws.

The in vitro experiments had been performed with xylanase or xylanase and ferulic acid esterase (FAE) or the with enzyme composition containing xylanase, FAE, surfactants and stabilizers. The corresponding amount of enzyme on the basis of feed to be treated was mixed into water, at a ratio of minimum 1:2 or a maximum of 1:5 parts feed:water. The feed was weighed and soaked with enzymes or enzyme composition with water and incubated at room temperature (25-34° C.) for a period of 1 to 4 h for different experiments. After incubation with enzymes for a presoaking period, the extracts were filtered and the supernatant was analyzed for presence of reducing sugars using Nelson Somoygi' s method.

### EXAMPLE 1

### Xylanase Dose Response

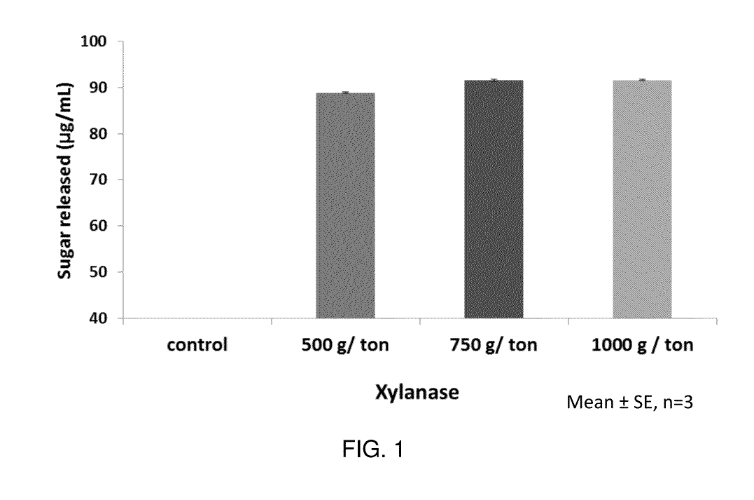

To determine the influence of xylanase on rice straw, an experiment was performed by preparing a presoaking enzyme composition with xylanase at 500 g/ton, 750 g/ton and 1000 g/ton doses in 10 mL water and soaking 200 mg of rice straw into this. This mixture was incubated at 29-30° C. for 3 h. The released reducing sugars were estimated and the results were seen to be as in FIG. 1. The supplementation of xylanase improved sugar released from the rice straw compared to control without any enzyme supplementation. However, addition of xylanase did not show any improvement in reducing sugar released beyond 500 g/ton. This might be due to the fact that, the access of xylanase is hindered by the substitution, ferulic acid and phenolic acid cross links in the rice straw.

### EXAMPLE 2

### Synergy Between Xylanase and Ferulic Acid Esterase (FAE)

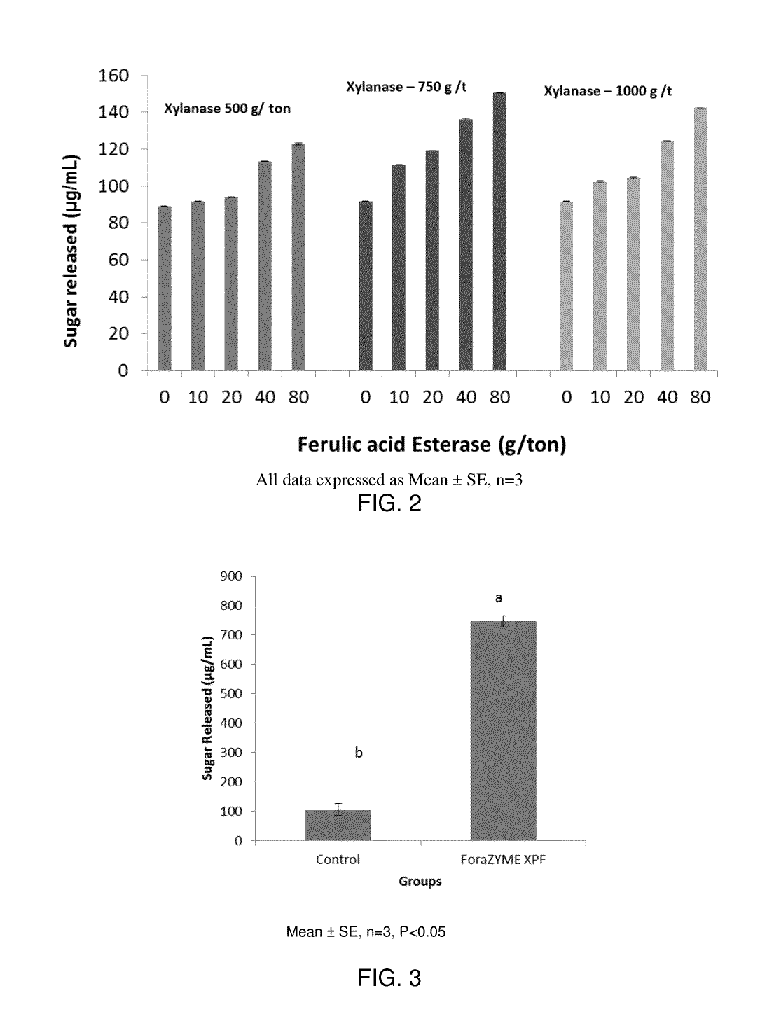

The potential synergy between xylanase and FAE in degrading rice straw and releasing reducing sugars was analyzed. This was performed using different combinations of xylanase and FAE ranging from 500 g/ton, 750 g/ton and 1000 g/ton of xylanase and 10 g/ton, 20 g/ton, 40 g/ton and 80 g/ton of FAE in 10 mL water. Different doses of xylanase and FAE were mixed with water and 200 mg of rice straw was soaked in the mixture at 27-31° C. for 3 h. The sugars released were analyzed and the results are shown in FIG. 2. The addition of FAE along with xylanase to the rice straw improved the sugar released from rice straw. A linear dose response was observed at all dosage of xylanase in combination with FAE. This might be attributed to the fact that FAE breaks the ferulic acid and diferulate cross links in the rice straw and provides the access for xylanase to penetrate the feed substrate and improves sugar release from rice straw.

### EXAMPLE 3

### Presoaking With ForaZYME XPF

Based on the previous experiments, a blend of enzyme composition containing xylanase, FAE, surfactants and stabilizing agents was prepared and named as ForaZYME XPF. The enzyme composition at a dose of 500 g/ton of forage was mixed with water and 200 mg of rice straw was soaked in this for 3 h at 30° C. The rice straw soaked with only water without enzymes served as control. The reducing sugar released was quantified and the results obtained were as shown in FIG. 3. From FIG. 3 it was observed that presoaking of rice straw with ForaZYME XPF significantly improved reducing sugar released. This could be attributed to the action of xylanase and FAE in the ForaZYME XPF composition which breaks the non-starch polysaccharides in the rice straw.

### EXAMPLE 4

### Dose Response of ForaZYME XPF

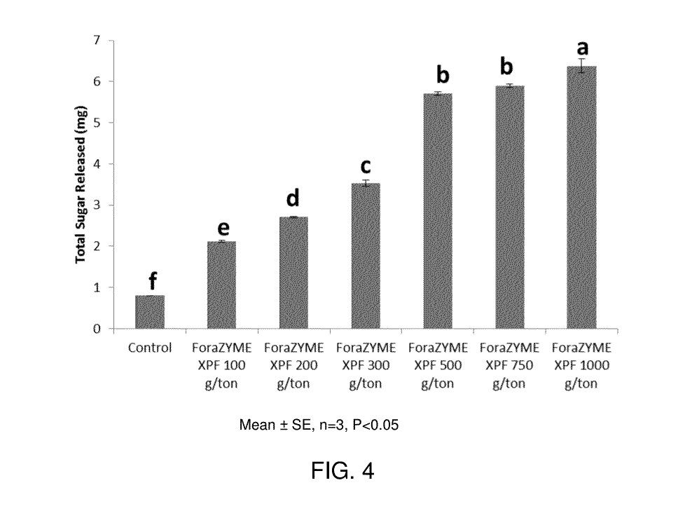

Further to previous experiments, the effect of adding different enzyme doses in the presoaking composition was analyzed. This experiment was performed by soaking 200 mg straw with 10 mL of the presoaking composition with 100 g/ton, 200 g/ton, 300 g/ton, 500 g/ton, 750 g/ton and 1000 g/ton of ForaZYME XPF in 10 mL water. Rice straw soaked in water without enzymes served as the control. The reducing sugars were read and are represented in FIG. 4. The addition of ForaZYME XPF to rice straw significantly improved reducing sugar released compared to control. A linear dose response was observed with addition of ForaZYME XPF at all doses.

### EXAMPLE 5

### Time Response Analysis

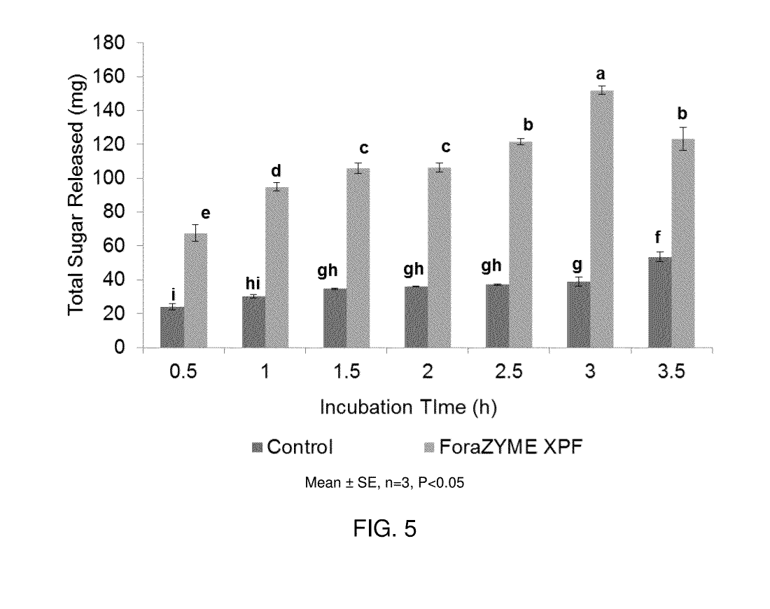

In order to assess the effects of presoaking straw in the enzyme composition at varied intervals of time, a time response study was conducted. 200 mg of rice straw was incubated in 10 mL of enzyme composition with 500 g/ton dose of ForaZYME XPF and incubated at 32° C. for a time duration ranging from 0.5 h to 3.5 h. Samples were withdrawn every 30 minutes and analyzed for reducing sugars by Nelson's method. The sugars released at different time intervals were assessed and the results are shown in FIG. 5. The addition of ForaZYME XPF significantly improved reducing sugar released from rice straw at each time interval, compared to control. A gradual increase in reducing sugar was observed in the ForaZYME XPF group corresponding to an increase in time duration of presoaking.

### EXAMPLE 6

### ForaZYME XPF on Total Mixed Ration (TMR)

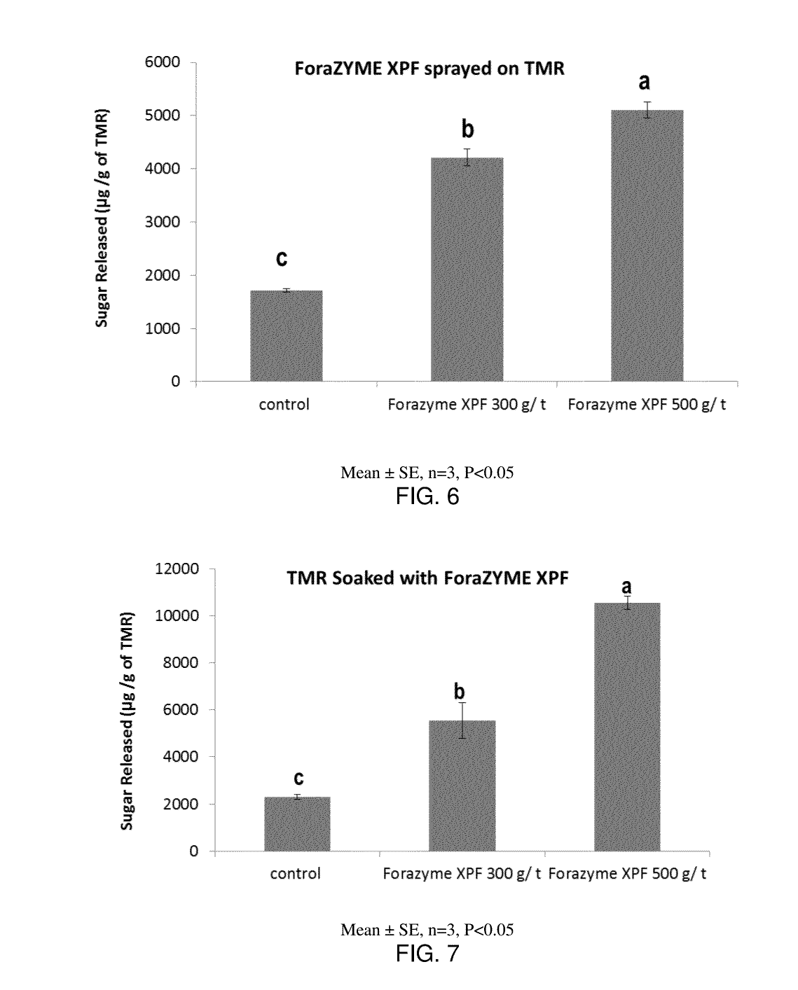

Experiment 1: TMR feed, a mixture of dry, green fodder and concentrates was obtained from commercial farm in India. ForaZYME XPF at dosage of 300 g/ton and 500 g/ton was diluted in water to a volume of 5 mL and sprayed on to 5 g of TMR feed. The sprayed feed was incubated at 31° C. for 1 h. Post incubation, TMR was then extracted in 250 mL of water with mild stirring for 10 minutes and the extract was read for released sugars. The results are as shown in FIG. 6.

Experiment 2: The sugars released from TMR feed when presoaked with enzyme compositions were also analyzed. For this, 5 g of TMR feed was soaked in 250 mL water containing ForaZYME XPF at 300 g/ton and 500 g/ton dosage. This was incubated for 1 h at 31° C. and the extracts were read for reducing sugar released. The results of this experiment were as shown in FIG. 7. The soaking or spraying of water without any enzymes on TMR were taken as control.

From FIGS. 6 and 7, it was observed that addition of ForaZYME XPF on TMR significantly improved reducing sugar released compared to control. The addition of ForaZYME XPF improved reducing sugar released from TMR by both the spraying and soaking method of application of enzyme on TMR. However, the soaking of TMR with ForaZYME XPF gave comparatively more sugar released, compared to spraying of ForaZYME XPF on TMR.

### EXAMPLE 7

### ForaZYME XPF on Commercial Pellet Feed

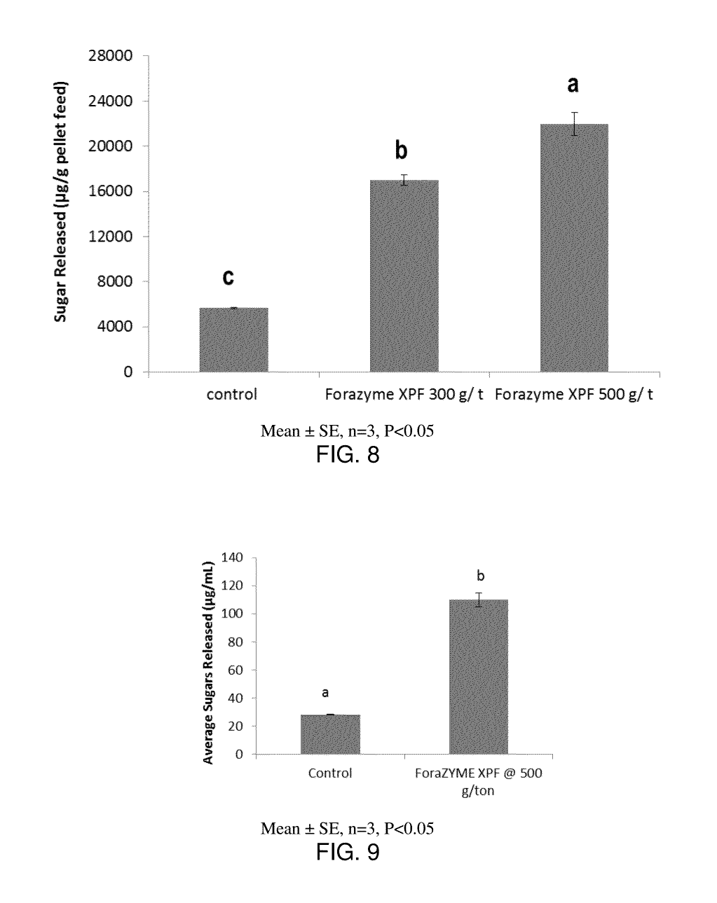

The sugar released from commercial pelleted feed, when presoaked with the ForaZYME XPF, was analyzed in this study. The commercial pellet feed was obtained from a commercial feed miller in India. Commercial pellet feed (5 g) were soaked in 250 mL of water containing ForaZYME XPF at 300 g/ton and 500 g/ton dosage. The soaking was carried out at 32° C. for 1 h and the extracts were analyzed for reducing sugar released by Nelson's method. The soaking of pellet feed in water without any enzymes were taken as control. The results are as represented in FIG. 8. It was observed that, soaking of pellet feed with ForaZYME XPF significantly improved sugar released compared to control.

### EXAMPLE 8

### Influence of ForaZYME™ XPF on Various Feedstuffs

The ruminant ration typically consists of cereal grains, green fodder and dry fodder. This study investigates the efficacy of ForaZYME™ XPF on various feedstuffs ruminant rations. Two application methods, pre-soaking and spraying, were investigated in this study. The various feedstuffs used in this study were concentrate pellet feed, soya forage and sugarcane bagasse. It was observed that there was a significant increase in the release of sugars when feedstuffs were treated with ForaZYME™ XPF for 3 hours (P<0.05), irrespective of application method. It was also observed that the sugar release with the pre-soaking application method was higher than the spraying application.

Exogenous enzymes have been used successfully for many years to improve the nutritive value of diets in the monogastric animals. This success has not been observed in the ruminant animals reflecting their more complex digestive system and the greater concomitant challenge to nutritional science. To overcome this challenge, we have reported ForaZYME™ XPF for presoaking application of forages. ForaZYME™ XPF has xylanase and ferulic acid esterase (FAE) as main enzyme activities.

The typical diet of ruminant animals contains dry fodder, green fodder and concentrates. We have previously reported that, ForaZYME™ XPF improves the digestibility of rice straw, one of the most widely used crop residues in India. This study investigates the influence of ForaZYME™ XPF in improving the digestibility of concentrate feed as well as various other dry fodders used in ruminant rations.

### Materials and Methods

Enzymes. The enzyme activities of ForaZYME XPF includes 1,600,000 U/g of xylanase and 400 U/g of FAE

Enzyme Assay: All enzyme assays for xylanase and FAE were performed using standard methods.

Forages and Feed Collection:

1. Total mixed ration (TMR) was obtained from Sarda Dairy Farms, India

2. Concentrate pelleted feed was obtained from commercial feed miller in India

3. Sugarcane Bagasse, sourced from local markets in Chennai, India.

4. Soya forage, sourced locally from a farm in Northern India

Single samples of the feed/forage materials were obtained and analyzed in triplicates in this study.

Treatment Methods: Two different methods of pretreatment with enzymes, namely soaking and spraying on the various forages were used in this study.

Soaking Protocol: About 5 g of various feed stuffs as mentioned above were soaked in tap water in a 1:50 ratio with respective quantities of enzymes (as shown in Table 1). The treatment groups included were as shown in Table 1. The study was performed by incubating the respective amount of forages or feed in tap water (pH 7.2-7.3) at room temperature (28-32° C.) for 3 h without shaking. The extracts were filtered using a Whatmann filter paper, boiled for about 10 minutes to stop the enzymatic reaction and the reducing sugars were estimated by Nelson's Somoygi method. All experiments were performed in triplicates.

TABLE 1
Treatment groups for analysis. Total mixed ration,
Concentrate pelleted feed, Sugarcane Bagasse,
and Soya forage were used in this study.

| Groups | Dosage* |
|---|---|
| Control | No enzymes, feed materials |
| | soaked in tap water or |
| | sprayed with water |
| ForaZYME ™ XPF | 500 g/ton of feed material |

*Enzymes were dosed on dry weight basis of feedstuffs

Spraying Protocol: About 5 g of the various feed stuffs mentioned above were used to evaluate the spraying application of enzymes. The concentrate pellet feed was not included in this method of enzyme application. The treatment groups were as shown in Table 1. The spraying of enzymes was done using a locally purchased spray nozzle, fitted loosely on to a 15 mL graduated non sterile plastic centrifuge tube (Tarsons, India). About 5 mL of this enzyme or water (control) was sprayed on to the forage materials using the spraying apparatus. When the spraying had been completed, the aluminum foil containers were covered and incubated at room temperature (28-32° C.) for a period of 3 h. Then, the contents of the foil packs were transferred to 250 mL conical flasks (Borosil, India) and extracted in 200 mL of tap water on a magnetic stirrer for 10 minutes. The extracts were filtered using a Whatmann filter paper, boiled for about 10 minutes to stop the enzymatic reaction and the reducing sugars were estimated by Nelson's Somoygi method. All experiments were performed in triplicates.

Statistical analysis: Mean values were calculated for each group. One way Analysis of Variance (ANOVA) was performed using STATGRAPHICS Plus 5.1 software to study the significance between different groups. The data were analyzed by Least Significant Difference (LSD) method and differences at P<0.05 are considered significant. For some of the data, differences at P<0.10 are considered significant.

### Results

Concentrate Pelleted Feed—Soaking: The sugar released from the concentrated pellet feed by soaking in water or enzymes are shown in FIG. 9. The soaking of concentrate pellet feed with ForaZYME™ XPF showed higher (P<0.1) sugar release compared to control, soaked in water.

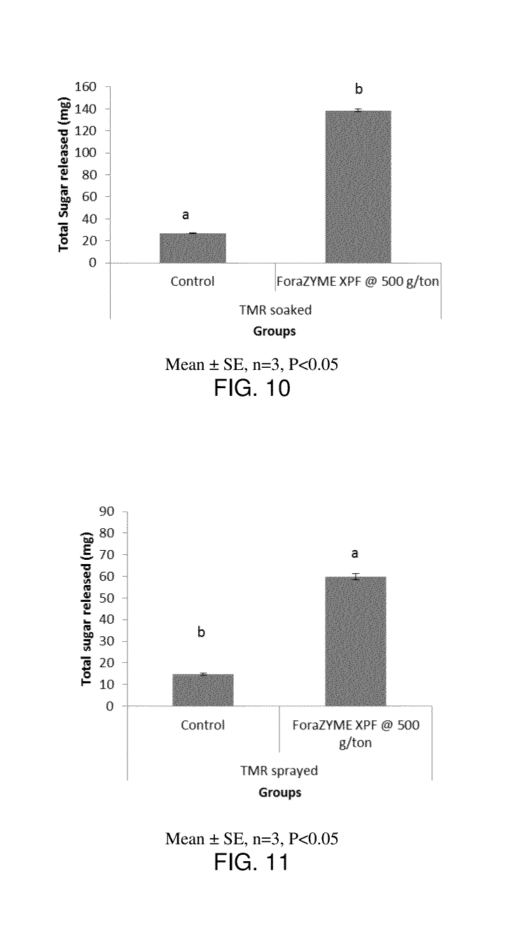

TMR Soaking & Spraying: The sugars released from TMR with soaking and spraying applications are shown in FIGS. 10 and 11. In both the method of application, addition of enzymes released more sugar compared to control soaked or sprayed in water. The addition of ForaZYME™ XPF at 500 g/ ton resulted in significantly higher sugar released from TMR, compared to VPT at 750 g/ton. However, the soaking was observed to release more sugars compared to spraying application.

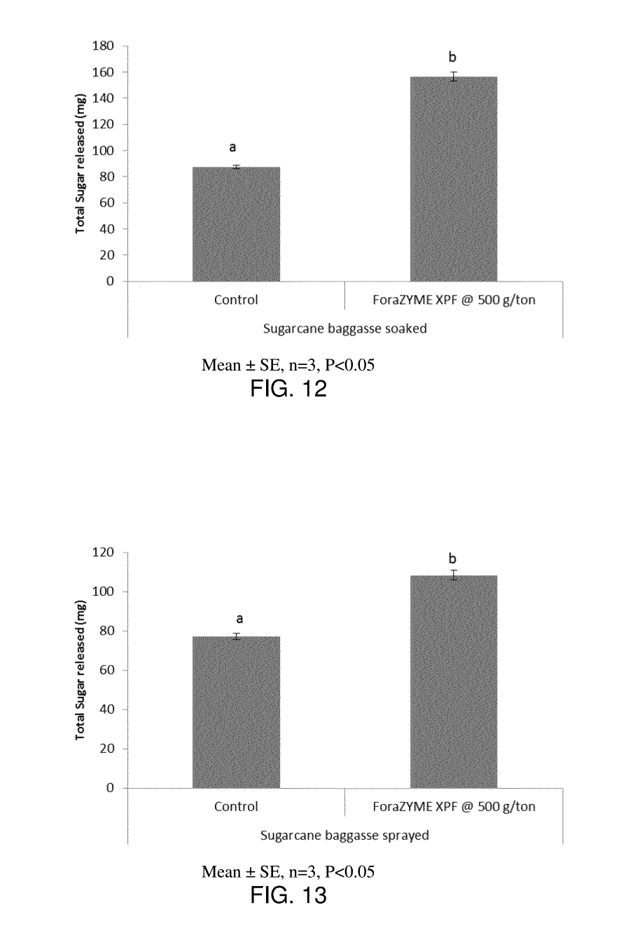

Sugarcane Bagasse Soaking & Spraying: The sugar released from sugarcane bagasse with soaking and spraying application was shown in FIGS. 12 and 13. The sugar release from sugarcane bagasse even from water soaked or sprayed is higher compared to other feedstuffs tested. As observed earlier, the ForaZYME™ XPF showed higher (P<0.05) sugar release from sugarcane bagasse in both soaking and spraying applications, compared to control

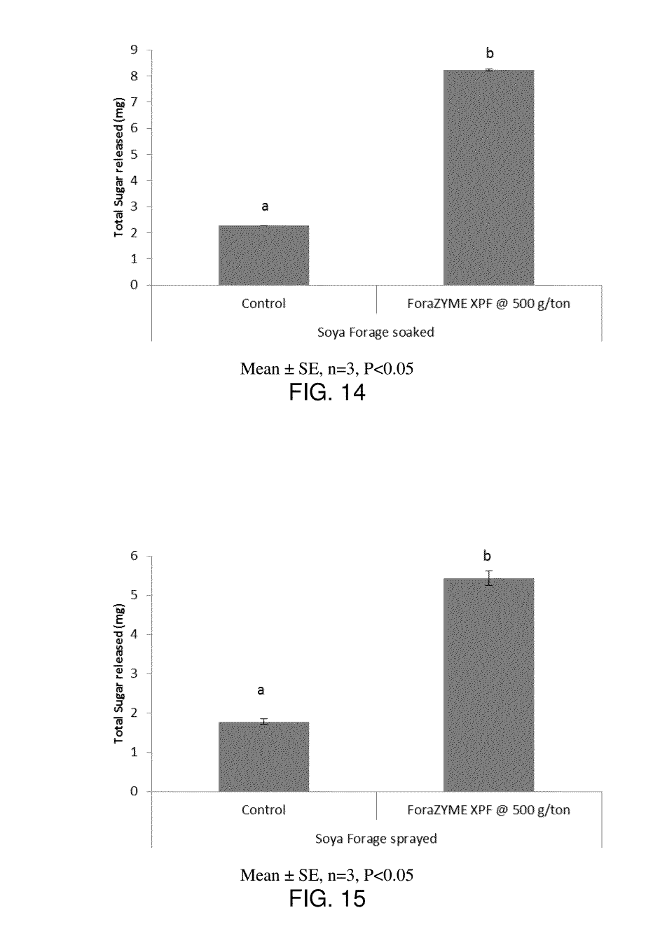

Soya Forage Soaking & Spraying: The sugar released from soya forage with soaking and spraying application was shown in FIGS. 14 and 15. The sugar released from soya forage is comparatively lower in all treatment groups compared to other feedstuffs tested. However, the addition of enzymes released higher (P<0.05) sugar release compared to control soaked in or sprayed with water.

### Discussion

The influence of ForaZYME™ XPF on the various ruminant feedstuffs was analysed in this study. We have shown previously the application of ForaZYME™ XPF improves the sugar release from rice straw with pre-soaking method. As soaking may not be possible in all feedstuffs and farms, spraying methodology was tested in this study, as another possible method of application.

Concentrated feeds are given to ruminant animals in the form of mash or pellets. These concentrates are generally soaked in water for few hours before fed to animals. As this was a traditional practise in India, the pellets were soaked with enzymes and read for sugars released. Soaking of pellets with ForaZYME™ XPF showed significantly higher sugar release compared to control, which illustrates the improvement in digestibility of concentrate feed.

Sugarcane bagasse and Soya forage were used as a fodder in some regions of northern India. The soaking or spraying with ForaZYME™ XPF to these fodders improved the sugar release compared to control, indicating the improvement in digestibility. When these predigested fodder are fed to animals, this improves fiber digestion in rumen and improves animal performance.

Increased sugar release from ForaZYME™ XPF can also be attributed to the action of FAE. There is a synergy of FAE and xylanase in NSP deconstruction and improving sugar release from natural substrates.

To our knowledge, there is no reported data on in vitro spraying of enzymes to ruminant diets. However, Kung et al., studied the effects of spraying exogenous enzymes on Total Mixed Ration (TMR) fed to lactating cows. See, M. A. Kung, Jr., et al., The Effect of Fibrolytic Enzymes Sprayed onto Forages and Fed in a Total Mixed Ratio to Lactating Dairy Cows. 85 J. DAIRY SCI. 9, (2002). They had observed that cows fed forage treated with cellulase and xylanase enzyme mixtures tended to produce about 2.5 kg more fat corrected milk (FCM) than cows fed untreated forage. The overall, conclusion of this study was that fibrolytic enzymes can be used to improve milk production in lactating cows with a spraying application.

The study in discussion here too follows a similar methodology and from the experiments, it was observed that, ForaZYME™ XPF has ability to improve the digestibility of various forages and feed materials with presoaking and spraying application.

### EXAMPLE 9

### Influence of ForaZYME™ XPF on In Vitro Fiber Digestability

Fiber constitutes the larger percentage of ruminant ration and increase in the digestibility of fiber is of great importance in dairy farming. ForaZYME™ XPF is a blend of xylanse and ferulic acid esterase (FAE) shown to improve the sugar release from rice straw with presoaking application. This study investigates the influence of ForaZYME XPF in improving the fiber digestibility of rice straw. The experimental groups included rice straw as such, rice straw soaked in water as control, rice straw soaked in ForaZYME XPF and rice straw soaked in Vista Pre T. The changes in neutral detergent fiber (NDF) content and acid detergent lignin (ADL) among the treatments were analyzed. It was observed that there was a significant reduction in the NDF, in the group soaked with ForaZYME XPF at 500 g/ton, in comparison to all the other groups. A similar trend was also observed in the analysis of ADL in the group treated with ForaZYME XPF at 500 g/ton. This study demonstrates that presoaking of rice straw with ForaZYME XPF improves fiber digestibility. When this predigested straw is fed to ruminant animals it improves animal performance. Crop residues such as wheat and rice straw are used as forages for dairy cattle. Fiber is the major component of forages, which is not fully digested in the rumen. Dietary fiber is primarily derived from plant material and is composed of complex, non-starch carbohydrates (NSP) and lignin. Turner N. D. and Lupton J. R. 2 Dietary Fiber. Adv. Nutr., 151-152 (2011). The presence of phenolics and lignins in the NSP limits the digestibility of the straw. There are numerous reports and evaluations of commercial and experimental enzymatic products for ruminant animals. See, e.g., Id. Xylanases and cellulases have most commonly been used for ruminants. See, Mendoza G. D., et al. Considerations on the use of exogenous fibrolytic enzymes to improve forage utilization, Sci. World J., Article ID 247437 (2014).

We have developed an enzyme product, ForaZYME™ XPF for presoaking application to improve the digestibility of dry fodder. We have reported the influence of ForaZYME XPF in improving the sugar release from rice straw with presoaking application. The present study investigates the ability of ForaZYME™ XPF in improving the fiber digestibility of rice straw.

### Materials and Methods

Enzymes. The enzyme activities of ForaZYME XPF includes 1,600,000 U/g of xylanase and 400 U /g of FAE Substrate and Pre-Soaking Conditions. The substrate used in the presoaking studies was rice straw cut to 2 cm length, obtained from a local market in India. The soaking was done in tap water with a pH 6.5-7.2 and incubated at room temperature (28 to 35° C., depending on the day's temperature) for 3 h without stirring. The pre-soaking was done using 1 part of rice straw soaked in 50 parts of the solution of water and enzyme, throughout the various experiments described in this study. All enzyme dosages were added according to the dry weight of rice straw used. The soaking for each individual experiment was carried out in triplicate.

Treatment Groups. The details of treatment groups used in the experiments are shown in Table 2.

TABLE 2
Treatment groups used in the NDF analysis and ADL estimation

*The soaking of straw with different treatments was performed at
room temperature for 3 h as described in substrate and pre-
soaking conditions, in triplicates.

Neutral Detergent FiberAnalysis. NDF analysis was performed to understand the extent of fiber degradation by the exogenous enzymes used. About 2 g of the rice straw was taken as such or pre-soaked, as mentioned in Table 1, in triplicates. After presaoking, the straw from each treatment group as filtered, transferred into a 500 ml spout-less beaker and boiled in 200 ml 1.25% sulphuric acid for 30 minutes. This was then filtered and washed with distilled water until free from acid. The filtrate was further boiled in 200 ml 1.25% Sodium hydroxide for 30 minutes. This was once again filtered, washed as before and transferred to a pre weighed silica crucible. The filtrate was then dried at 103° C. for 2 hours, cooled and weighed again. The weighed crucible with the filtrate was then placed in a muffle furnace at 550° C. for 2 hours, cooled and once again weighed. The loss in weight resulting from incineration corresponds to the weight of NDF. The NDF (%) was calculated as follows:

$$Calculation of NDF \% . \\ NDF ( \% ) = \frac{( a - b )}{w} \times 100. \qquad Equation 1$$

### Wherein,

a=Weight of the crucible with treated residue after drying

b=Weight of crucible post incineration

w=Initial weight of sample

Acid Detergent Lignin (ADL). The analysis of the lignin content was done as described by Van Soest. See, P. J. Van Soest, Use of detergents in the analysis of fibrous feeds. II. A rapid method for the determination of fiber lignin. 46 J. ASS'N. OFF. AGR. CHEM. 829-835 (1963). The straw samples were presoaked as mentioned in Table 1, in triplicates. After the presoaking period of 3 h, the samples were filtered and the residue was boiled with 100 mL of an acid detergent solution of 20 g of cetyltrimethyl ammonium bromide in 1 L of 1N sulphuric acid for 30 minutes, filtered, washed and dried at 100° C. overnight. The dried residue representing Acid Detergent Fiber (ADF) was further treated with 72% sulphuric acid to dissolve cellulose components in the sample and dried. The dried residues were weighed and incinerated. The weights of the incinerated samples were used to determine the crude lignin fraction. The ADL % was calculated using the following formula.

$$Calculation of Acid Detergent Lignin ( \% ) . \\ ADL \% = \frac{{W}_{1} - {W}_{2}}{W} \times 100. \qquad Equation 2$$

### Wherein,

W₁=Weight of crucible with treated residue (ADF)

W₂=Weight of crucible post incineration (lignin fraction)

W=Initial weight of sample

Statistical analysis: One way Analysis of Variance (ANOVA) of all data obtained was performed using STATGRAPHICS Plus 5.1 software to study the significance between different groups. The data were analyzed by Least Significant Difference (LSD) method and differences at p<0.0005 were considered significant.

### Results

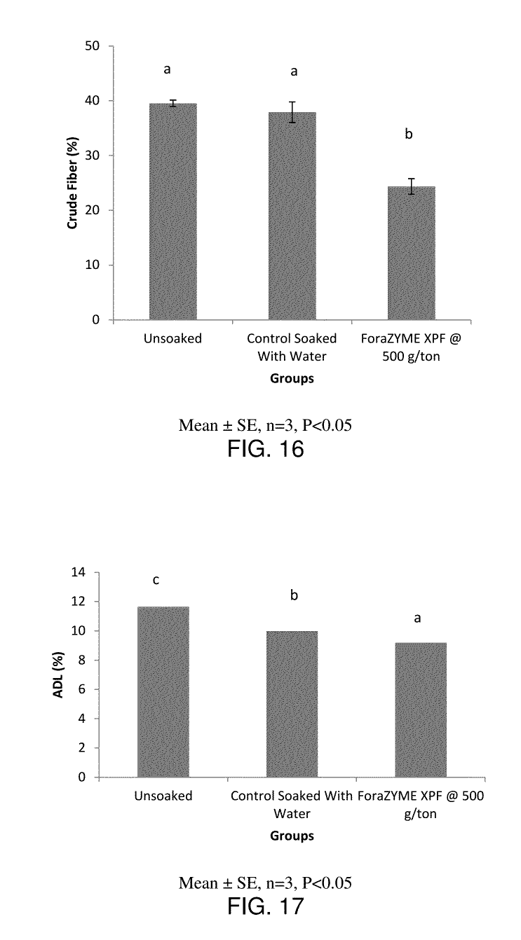

Neutral Detergent Fiber Analysis. The influence of ForaZYME XPF on the NDF content was analyzed and the results are shown in FIG. 16. There was a significant decrease (p<0.005) in the NDF content in the straw soaked with ForaZYME XPF (24.34%) as compared to the control soaked straw (37.92%) and unsoaked straw (39.53%). The reduction of NDF content upon soaking with ForaZYME XPF was evident from these results. It was also noted that there was a minor numerical reduction in the NDF levels when the straw was soaked in water without enzymes.

Acid Detergent Lignin Analysis. The effect of pre-soaking with ForaZYME XPF on the ADL content was shown in FIG. 17. The ADL % in untreated straw was seen to be about 11.65%, when the straw was soaked in water it gave a reduction of about 1.6%. This was further significantly reduced when the soaking was carried out in a mixture of water with enzymes, ForaZYME XPF (9.19%). Even though the reduction in lignin content in the treated samples was significant (n=4, p<0.005), there was no significant difference between the ADL content reduction with the two different enzyme products used.

### Discussion

The efficacy of ForaZYME XPF to digest fiber and lignin has been analyzed in this study. Rice straw contains 25-45% cellulose, 20-30% hemicellulose and 10-15% lignin⁹. See, Qiu Z., et al., Enzymatic hydrolysis of alkali-pretreated rice straw by Trichoderma reesei ZM4-F3, 32 BIOMASS & BIOENERGY 12, 1130-35 (2008). The use of enzymes in high fiber forages has previously been studied. See, e.g., Kung L. Jr., et al., The Effect of Fibrolytic Enzymes Sprayed onto Forages and Fed in a Total Mixed Ration to Lactating Dairy Cows, 85 J. DAIRY SCI. 2396-2402 (2001). There were reports of increased milk production even with decreased fiber diets, upon supplementation with enzymes. See, e.g., H. M. Gado et al., Influence of Exogenous Enzymes on Nutrient Digestibility, Extent of Ruminal Fermentation as well as Milk Production and Composition in Dairy Cows, 154 ANIMAL FEED SCI. & TECH. 36-46 (2009); A. T. Adesogan, et al., Strategic Addition of Dietary Fibrolytic Enzymes for Improved Performance of Lactating Dairy Cows, Florida Ruminant Nutrition Symposium, Best Western Gateway Grand, Gainesville, Flor. (2003). It has been previously observed that applying a blend of cellulase and xylanase enzyme products to forages prior to feeding increased actual milk production. See, D. J. Schingoethe, et al., Response of Lactating Dairy Cows to a Cellulase and Xylanase Enzyme Mixture Applied to Forages at the Time of Feeding, 82 J. DAIRY SCI. 996-1003 (1999).

With the reduction in the NDF and ADL contents, we can surmise that there is a significant action of the enzymes on the forages. The breakdown of fiber with a three hour pre-soaking with enzymes can prove to be a significant benefit for fiber utilization in the rumen. The partial fiber digestion prior to feeding might result in an increased fiber degradation and energy release in the rumen. Similar results have also been observed in goats and steers fed pre treated feed materials the treatment groups were seen to exhibit higher weight gain. See, S. H. Hong, Effects of Enzyme Application Method and Levels and Pre-treatment Times on Rumen Fermentation, Nutrient Degradation and Digestion in Goats and Steers, 16 ASIAN-AUST. J. ANIM. SCI. 3, 389-93 (2003). When the lignin content is reduced, there will be an increase in the digestibility of the forage. With an increase in the digestibility, an increase in milk production can also be observed. These studies prove that the pre-soaking application of ForaZYME XPF does increase the digestibility of straw.

### EXAMPLE 10

### Influence of ForaZYME™ XPF on Milk Yield

Trial 1. The compositions of the present invention were tested for their effect on milk yield in dairy cattle. The 21 cattle were grouped into three groups of seven based on a two-week pre-observation period of milk yield data. The duration of the trial using enzyme supplementation covered a period of 30 days. The cattle were in the early lactation phase. Rice straw was presoaked in a solution of water [1:3] in which the treatments of Table 3 were added. The rice straw was presoaked in the corresponding solution for a minimum of three hours and for a maximum as determined by the practice of the dairy farm.

TABLE 3
Treatment Groups

| No | Group | Treatment |
|---|---|---|
| 1 | C (control) | Forage soaked in water |
| 2 | Treatment 1 | Water supplemented with 300 g/ton ForaZYME XPF |
| 3 | Treatment 2 | Water supplemented with 500 g/ton ForaZYME XPF |

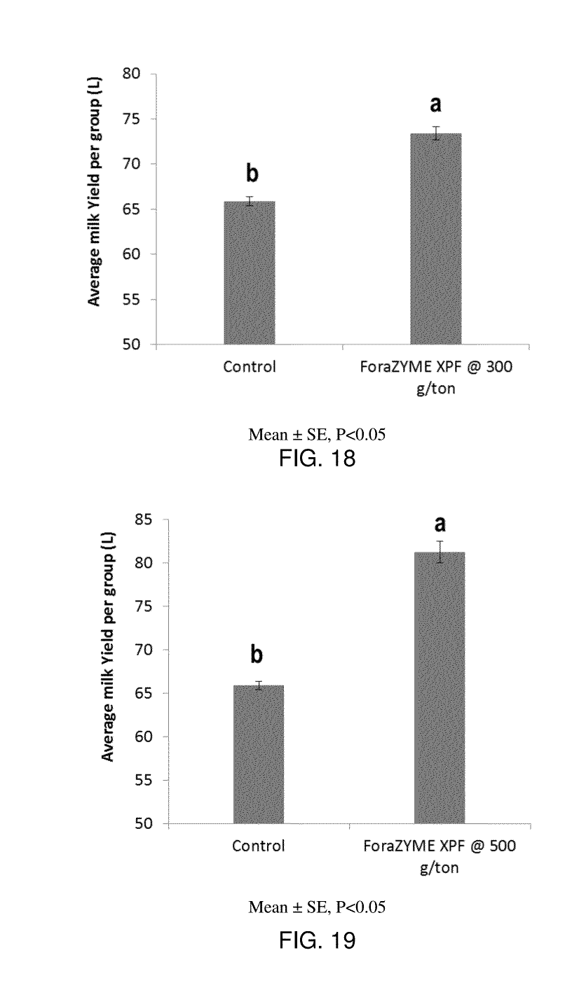

The results are shown in FIGS. 18 and 19. Presoaking treatment with ForaZYME XPF at 300 g/ton improved milk yield by 1 L per animal per day; treatment with ForaZYME XPF at 500 g/ton improved milk yield by 2 L per animal per day. In addition, the farm manager reported that the grains and straw excreted in manure were less in the enzyme supplemented groups compared to the control.

Trial 2. The compositions of the present invention were tested for their effect on milk yield in dairy cattle. The 24 cattle were grouped, 12 in each group, based on a two-week pre-observation period of milk yield data. The duration of the trial using enzyme supplementation covered a period of 30 days. The cattle were in the mid-lactation phase. Rice straw was presoaked in a solution of water [1:3] in which the Control and Treatment 1 treatments of Table 1 were added. The rice straw was presoaked in the corresponding solution for a minimum of three hours and for a maximum as determined by the practice of the dairy farm.

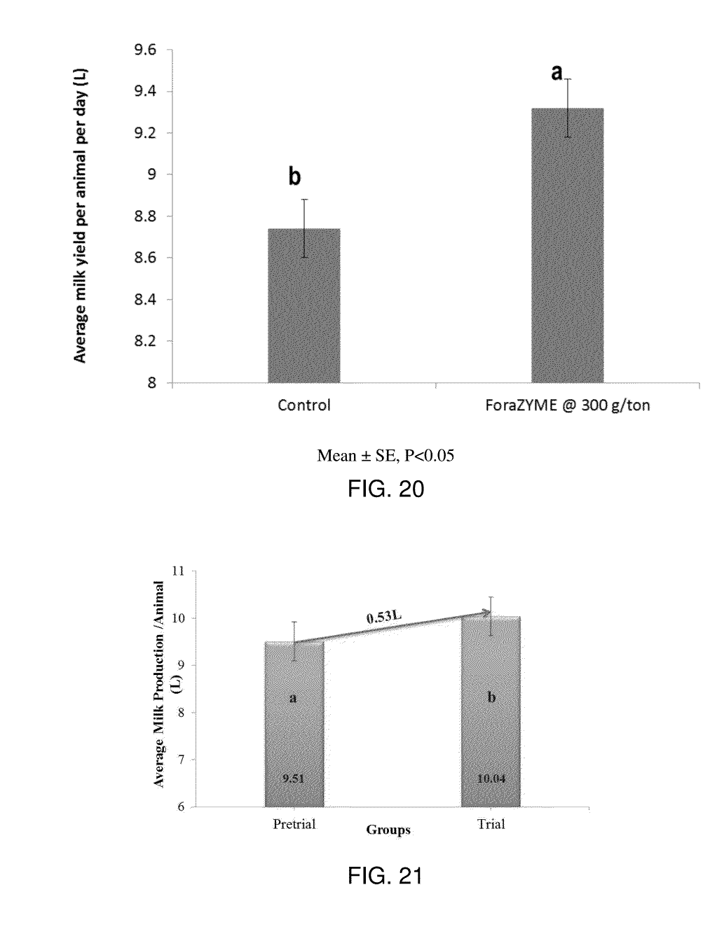

The results are shown in FIG. 20; presoaking treatment with ForaZYME XPF at 300 g/ton improved milk yield by 0.6 L per animal per day. There was a decrease in milk yield in the control group due to the lactation phase and cold climactic conditions, but milk yield was maintained in the enzyme-supplemented group.

### Statistical Analysis

One way Analysis of Variance (ANOVA) was performed using STATGRAPHICS Plus 5.1 software to study the significance between different groups. The data were analyzed by Least Significant Difference (LSD) method and differences at P<0.05 are considered significant.

### Example 11

### ForaZYME™ XPF Improves the Performance of Murrah Buffalo

The trial investigates the milking performance of Murrah buffalo, fed with wheat straw pre-soaked with Forazyme XPF in commercial farm conditions.

### Materials and Methods

The trial used 10 Murrah buffalo cows in the mid-lactation phase. During the trial stage, the animals were fed wheat straw that had been soaked in water containing ForaZYME XPF for 1 hr prior to feeding (80 kg of wheat straw soaked in 160 L of water containing 40 ml of the enzyme treatment) (Table 4). The trial period covered 30 days of which 7 days was a pre-trial stage and 23 days was a treatment stage.

TABLE 4
Observation Period

| S. No | Group | Treatment |
|---|---|---|
| 1 | Pre-trial* | Wheat straw soaked in water |
| 2 | Trial* | Wheat straw soaked in water containing ForaZYME ™ |
| | | XPF |

*Soaking application of wheat straw for 1 hr using water or ForaZYME XPF. ForaZYME ™ XPF soaked wheat straw fed to animals after 1 hr. Pre-trial period, Wheat straw soaked in water for 1 hr, then fed to animals. During the trial and pre-trial period in the treatment group average milk production in the animals were noted in the daily basis.

### Statistical Analysis

All the data were analyzed by t-test using Statgraphics Centurion XVI software (version 16.2.04). Statements of statistical significance are declared when P<0.05.

### Results and Discussion

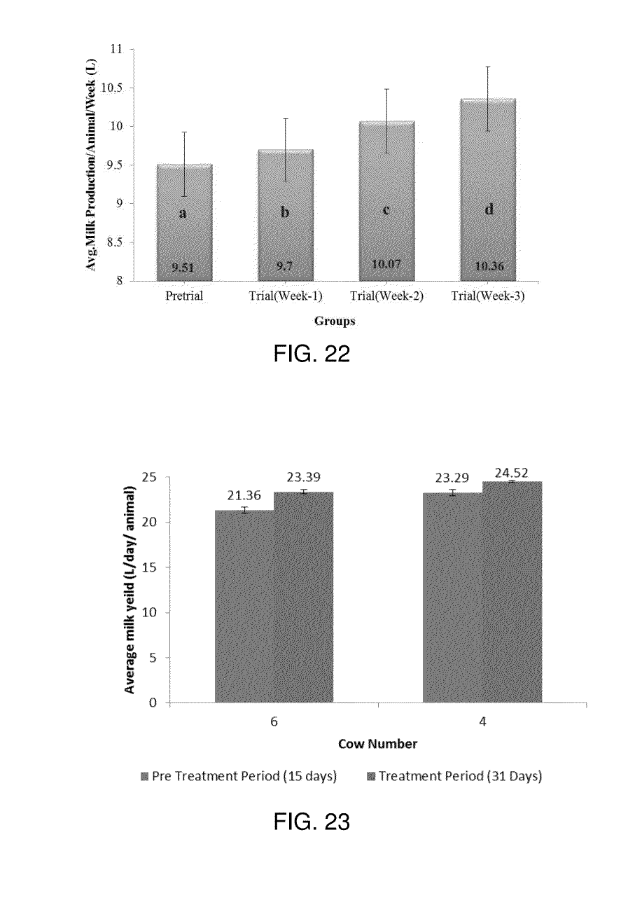

The average milk production per animal between pre-trial and trial in the treatment group is shown in FIG. 21. In the treatment group, it was observed that, there was 0.53 L milk increment during the trial compared to pre-trial period. FIG. 22 shows the weekly milk yield data during the pre-trial and trial period. It was observed that, ForaZYME™ XPF supplementation improved milk production in Murrah buffaloes during the treatment period compared to pre-trial. It was also observed that there is a consistent improvement in milk every week during the trial period. Pre-trial period—7 days and Trial period—23 days (n=10). All data expressed as mean±SE.

### EXAMPLE 12

### Influence of ForaZYME™ XPF in Improving the Performance of Dairy

The trial investigates the influence of ForaZYME XPF, with presoaking application of dry fodder, in improving the performance of dairy cattle at small scale farm conditions. From this trial, it was observed that, the presoaking of application of straw with ForaZYME XPF increased milk yield in dairy cattle with all lactation phases—early, mid and late lactation phases.

### Materials and Methods

The trial included 2 animals in early lactation, 2 animals in mid-lactation and 2 animals in late lactation phases. All animals were Holstein dairy cows. The forage used for feeding was a mixture of wheat straw and green fodder. The trial lasted for a total of 45 days of which 14 days were a pre-trial stage and 31 days of which were the trial stage. The farm consisted of about 12 animals in total, the animals were identified by ear tags and two animals at each lactation phase were used in the trial. The individual milk data per animal was collected during the pretrial period as well as in the duration of the trial. The feeding practice in the farm was to feed twice a day at both feeding times, the general ration included wheat straw as well as green fodder. The animals identified for the trial however, were fed only pre-soaked wheat straw.

ForaZYME XPF at 500 g/ton dosage was mixed with water. The enzyme diluted with water was used for soaking of wheat straw. After 1 h, the soaked straw was fed to animals.

### Results

The trial was designed to include cows from different lactation stages. The cows were selected to be 2 each in early lactation, mid-lactation and late lactation stages. The cows were fed twice daily, with soaked straw and unsoaked green fodder.

FIG. 23 shows the average milk yield of the cows in early lactation phase. There is a positive difference observed in the milk production between pretreatment and treatment period. The increase in milk yield was about minimum 1 L per animal per day in early lactation phase.

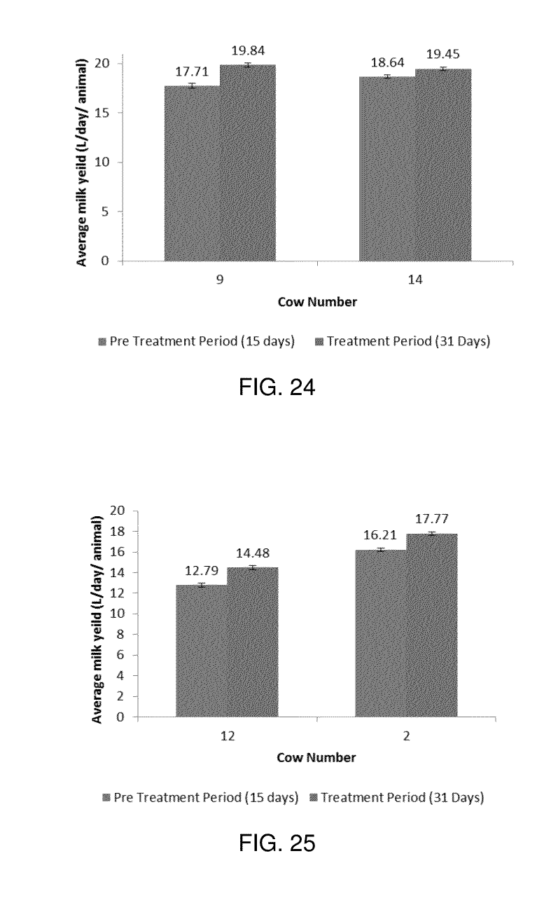

As seen in FIG. 24, there was a pronounced difference in the milk yield between pretreatment and treatment period. There was an average increase of minimum 1 L per animal per day in the mid lactation cows.

FIG. 25 shows the average milk yield comparison in late lactation cows between pretreatment and treatment period. There was an average increase of minimum 1.5 L/day/animal in late lactation stage cows.

### EXAMPLE 13

### ForaZYME™ XPF Improves the Performance of Lactating Cows

The trial demonstrates the benefit by using ForaZYME™ XPF with sprayed application on total mixed rations (TMR), improve the dairy cow performance of commercial farm conditions.

### Materials and Methods

The ForaZYME™ XPF trial included 40 animals with the same lactation period. The animals were distributed into two groups, control and treatment. Animals were fed with a corn silage-based TMR. Twenty mid-lactation stage animals were placed in each group. The TMR consisted of wheat straw, a concentrate mixture and corn silage treated with 500 ml of ForaZYME™ XPF that had been mixed with 60 L of water, then sprayed over the one ton of TMR. The treated TMR was mixed thoroughly and held for 30 mins for pre-digestion. Both groups were fed the control mixture (Treatment 1 of Table 5) for 7 pre-trial days and then the treatment group was fed the treated mixture (Treatment 2 of Table 5) for the 10 days of the trial.

TABLE 5
Treatment groups

| S. No | Group | Treatment |
|---|---|---|
| 1 | Control | Without supplementation - TMR soaked with water |
| 2 | Treatment | ForaZYME ™ XPF supplemented 500 ml/ton of |
| | | TMR* |

*Spraying application of TMR minimum 30 mins with ForaZYME ™ XPF. The enzyme diluted with water was used to spray TMR. The ForaZYME ™ XPF sprayed TMR fed to animals after 30 mins. Control group, TMR soaked in water for 30 mins was fed to animals.

### Results and Discussion

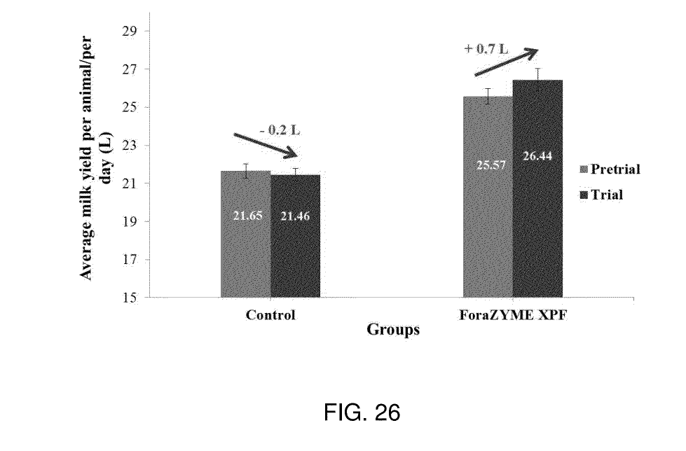

The average milk yield per animal between the control group and treatment group is shown in FIG. 26. In the control group, it was observed that, there was 0.2 L milk decrement during the trial period compared to pretrial period. The supplementation ForaZYME™ XPF with spraying application on TMR showed an increase of 0.7 L in trial, compared to the pretrial period. Pretrial period—7 days and Trial period—10 days (n=20). All data expressed as mean±SE.

We claim:

1. A method of improving the digestibility of an equine or ruminant animal ration, comprising the step of treating the equine or ruminant ration by wetting with an aqueous solution of a composition of enzymes comprising a xylanase and a ferulic acid esterase, resulting in improvement of animal performance.

2. The method of claim 1, wherein the treated ration is allowed to remain in contact with the composition of enzymes for a residence period of time prior to being fed to the animal.

3. The method of claim 1, wherein the xylanase is present in the composition of enzymes in an amount between 5% and 95% and the ferulic acid esterase is present in the composition of enzymes in an amount between 1% and 20%.

4. The method of claim 1, wherein the ration comprises at least one component selected from the group consisting of soya forage, sugarcane bagasse, wheat straw, rice straw, green fodder, and a total mixed ration.

5. The method of claim 1, wherein the ration is soaked in the aqueous solution of a composition of enzymes and the animal is fed both the ration and any remaining aqueous solution.

6. A method of reducing the NDF in an equine or ruminant animal ration, comprising the step of treating the ration by wetting with an aqueous solution of a composition of enzymes comprising a xylanase and a ferulic acid esterase.

7. A method of increasing milk yield of a ruminant animal, comprising the step of treating a ruminant ration by wetting with an aqueous solution of a composition of enzymes comprising a xylanase and a ferulic acid esterase.

8. The method of claim 7, wherein the ruminant animal is a dairy animal in either the early lactation phase, the mid-lactation phase or the late lactation phase.

9. The method of claim 1, wherein the xylanase activity is between about 800,000 U/g and about 1520000 U/g and the ferulic acid esterase activity is between 4 U/g and about 80 U/g.

10. A method of reducing the lignin content in an equine or ruminant animal ration, comprising the step of treating the ration by wetting with an aqueous solution of a composition of enzymes comprising a xylanase and a ferulic acid esterase.
